(19) United States
(12) Patent Application Publication
(10) Pub. No.: US 2023/0066244 A1
(43) Pub. Date: Mar. 2, 2023

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Yoshikazu UGAI, Kanagawa (JP)

(73) Assignee: FUJIFILM Business Innovation Corp., Tokyo (JP)

(21) Appl. No.: 17/555,475

(22) Filed: Dec. 19, 2021

(30) Foreign Application Priority Data
Aug. 30, 2021 (JP) 2021-140319

(51) Int. Cl. G06F 11/30; G06F 11/34; G06F 8/61

(52) U.S. Cl. CPC G06F 11/3072; G06F 11/3476; G06F 11/3423; G06F 8/61

(57) ABSTRACT

An information processing apparatus includes a processor configured to: acquire signature information indicating whether an application program installed on the information processing apparatus is signed or not; and with the signature information indicating that the application program is not signed, transmit log information indicating an operation log of the application program to an external apparatus.

### CROSS-REFERENCE TO RELATED APPLICATIONS

This application is based on and claims priority under 35 USC 119 from Japanese Patent Application No. 2021-140319 filed Aug. 30, 2021.

### BACKGROUND

### (i) Technical Field

The present disclosure relates to an information processing apparatus, a non-transitory computer readable medium, and an information processing method.

### (ii) Related Art

Japanese Unexamined Patent Application Publication No. 2020-038439 discloses a log output device. The output device includes a generator, memory, and selector. Then generator generates a log indicating an execution history of an operation. The memory stores a first list listing first static information indicating that the operation malfunctions, a second list listing second static information indicating that the operation is normally performed, and a third list listing dynamic information used to determine depending on the log whether to output the log. The selector decides to output the log if the log generated by the generator includes the first static information and decides not to output the log if the log generated by the generator includes the second static information. The selector decides whether to output the log in accordance with the log generated by the generator and the third list.

Some of application programs installed on devices are signed in order to indicate authenticity thereof. A signed application program is more reliable than an application program not signed. Log information on the signed application program may not necessarily be transmitted to an external apparatus.

### SUMMARY

Aspects of non-limiting embodiments of the present disclosure relate to determining whether to transmit log information on an application program to an external apparatus depending on the reliability of the application program.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: acquire signature information indicating whether an application program installed on the information processing apparatus is signed or not; and with the signature information indicating that the application program is not signed, transmit log information indicating an operation log of the application program to an external apparatus.

### BRIEF DESCRIPTION OF THE DRAWINGS

Exemplary embodiments of the present disclosure will be described in detail based on the following figures, wherein:

FIG. 1 is a block diagram illustrating a configuration of an information processing system of a first exemplary embodiment;

FIG. 2 is a block diagram illustrating a hardware configuration of a computer of an image forming apparatus;

FIG. 3 is a block diagram illustrating a functional configuration of the image forming apparatus;

FIG. 4 is a flowchart illustrating an example of an information processing process of the first exemplary embodiment;

FIG. 5 is a flowchart illustrating an example of an information processing process of a second exemplary embodiment; and

FIG. 6 is a flowchart illustrating an example of an information processing process of a third exemplary embodiment.

### DETAILED DESCRIPTION

Embodiments of the disclosure are described with reference to the drawings. In each of the drawings, the same or equivalent elements are designated with the same reference numerals. The dimensions of some of the elements may be exaggerated for convenience of explanation and may thus not be proportional to actual dimensions.

### First Exemplary Embodiment

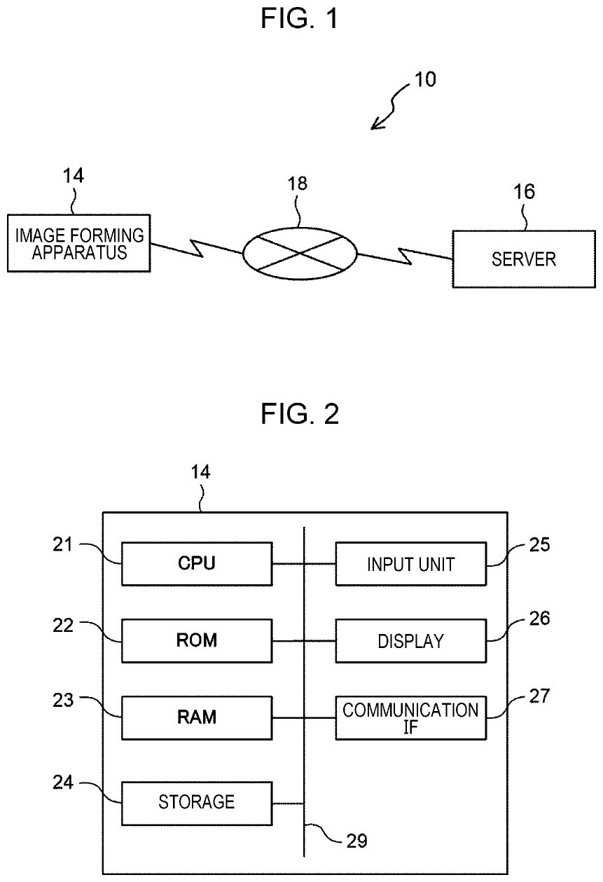

FIG. 1 illustrates a configuration of an information processing system 10 of a first exemplary embodiment.

The information processing system 10 in FIG. 1 includes an image forming apparatus 14 serving as an example of an information processing apparatus and a server 16 serving as an example of an external apparatus. The image forming apparatus 14 has an image print function, image reading function, image transmitting function, etc.

Multiple application programs are installed on the image forming apparatus 14. The image forming apparatus 14 acquires a variety of process results after executing the application programs. There may exist an application program harmful to the image forming apparatus 14 among the application programs. For example, such an application program may perform an operation of impeding a normal operation of the image forming apparatus 14, an operation of stealing secret information held by the image forming apparatus 14, or an operation of destroying data held by the image forming apparatus 14. Such an application program may not only perform an unscrupulous operation on the image forming apparatus 14 from the beginning, but also may perform an unscrupulous operation on the image forming apparatus 14 in response to an illegal access from outside.

Log information indicating an operation log of an application program is recorded and then transmitted to an external apparatus. The external apparatus analyzes the log information, thereby detecting an attack on the image forming apparatus 14. In such a case, if the operation log indicated by the log information satisfies a predetermined condition, the log information is transmitted to the external apparatus.

An application program installed on the image forming apparatus 14 may be signed to ensure authenticity thereof. The signed application program has a higher reliability than an unsigned application program. The singed application program is less likely to be harmful to the image forming apparatus 14 in response to an illegal access from outside.

If a decision as to whether to transmit the log information to the external apparatus is simply made in response to contents of the log information, the log information on the signed application program is also transmitted to the external apparatus. For this reason, although the application program has a higher reliability and is less likely to harm the image forming apparatus 14, the log information may be frequently transmitted to the external apparatus. If the log information on the application program having a higher reliability is transmitted to the external apparatus, not only traffic in communication network increases but also an analysis process of the log information to be performed on the external apparatus becomes complex. On the other hand, a decision as to whether to transmit the log information to the external apparatus is made in response to contents of the log information. In such a case, the log information on the application program not signed and thus having a lower reliability is to be transmitted to the external apparatus, but the log information may not actually be transmitted.

If a started (active) application program is not signed, the image forming apparatus 14 of the exemplary embodiment transmits to the server 16 the log information on an operation log of the application program. If the active application program is signed, the image forming apparatus 14 of the exemplary embodiment does not transmit to the server 16 the log information on the application program in principle. In this way, depending on the reliability of the application program, the image forming apparatus 14 may determine whether to transmit the log information to the external apparatus. The traffic in the communication network may thus be reduced by transmitting to the external apparatus only the log information on the application program having a lower reliability.

FIG. 2 is a block diagram illustrating a hardware configuration of a computer in the image forming apparatus 14.

Referring to FIG. 2, the image forming apparatus 14 includes a central processing unit (CPU) 21, read-only memory (ROM) 22, random-access memory (RAM) 23, storage 24, input unit 25, display 26, and communication interface (IF) 27. These elements are interconnected to each other via a bus 29 for communication.

The CPU 21 executes a variety of programs and controls the elements of the image forming apparatus 14. The CPU 21 reads a program from the ROM 22 or the storage 24 and executes the program on the RAM 23 serving as a working area. In accordance with the program stored on the ROM 22 or the storage 24, the CPU 21 controls the elements of the image forming apparatus 14 and performs a variety of arithmetic operations. According to the first exemplary embodiment, an information processing program and multiple application programs are stored on the ROM 22 or the storage 24.

The ROM 22 stores a variety of programs and a variety of data. The RAM 23 serves as the working area and temporarily stores a program or data. The storage 24 may be a hard disk drive (HDD), solid-state drive (SDD), or flash memory and stores a variety of programs including an operating system and a variety of data.

The input unit 25 includes a keyboard and a pointing device, such as a mouse, and is used to enter a variety of inputs.

The display 26 is, for example, a liquid-crystal display and displays a variety of information. The display 26 may be a touch panel and also serve as the input unit 25.

The communication IF 27 communicates with another apparatus, such as the server 16, and may comply with standards, such as Ethernet (registered trademark), fiber distributed data interface (FDDI), or Wi-Fi (registered trademark).

The image forming apparatus 14 implements a variety of functions using the hardware described above. The functions implemented by the image forming apparatus 14 are described below.

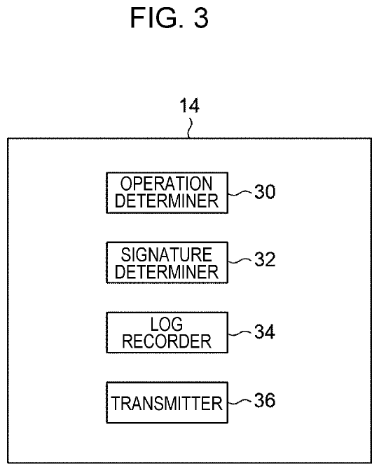

FIG. 3 is a block diagram illustrating a functional configuration of the image forming apparatus 14.

Referring to FIG. 3, the image forming apparatus 14 includes, as function blocks, an operation determiner 30, signature determiner 32, log recorder 34, and transmitter 36. The function blocks are implemented when the CPU 21 reads the information processing program from the ROM 22 or the storage 24 and executes the read information processing program.

When the CPU 21 in the image forming apparatus 14 starts an application program stored on the ROM 22 or the storage 24, the operation determiner 30 acquires operation information indicating an operation of the application program. In accordance with the operation information on the application program, the operation determiner 30 determines whether the operation of the application program is a predetermined operation.

The predetermine operation is a risky operation that is likely to cause harm to the image forming apparatus 14, an administrator of the image forming apparatus 14, or a user operating the image forming apparatus 14. For example, the predetermine operation is an operation of accessing predetermined data. For example, the accessing may include accessing to confidential data held by the image forming apparatus 14, accessing to system data used in the operation of the image forming apparatus 14, accessing to a certificate of the image forming apparatus 14 used in communications between the external apparatus and the image forming apparatus 14, accessing to an authentication token used in the communications between the external apparatus and the image forming apparatus 14, and accessing to a directory or a file in the image forming apparatus 14 where accessing to the directory or file is not permitted. The predetermined operation of the application program is hereinafter simply referred to as a “risky operation.”

When the application program starts operating, the signature determiner 32 acquires the signature information indicating whether the application program installed on the image forming apparatus 14 is signed or not. Specifically, when the application program stored on the ROM 22 or the storage 24 starts up, the signature determiner 32 acquires the signature information from a predetermined region in the application program.

In the acquisition of the signature information, the signature determiner 32 may acquire the signature information on the active application program from table data that is used to manage a list of multiple application programs and indicates whether each of the application programs is signed or not.

The signature determiner 32 verifies the acquired signature information. Specifically, the signature determiner 32 determines whether the application program is signed or not. If the signature information indicates that the application program is not signed, the signature determiner 32 stores on the log recorder 34 the log information indicating the operation log of the application program. On the other hand, if the signature information indicates that the application program is signed, the signature determiner 32 does not acquire the log information.

The log information acquired by the signature determiner 32 is stored on the log recorder 34.

The transmitter 36 transmits the log information from the log recorder 34. The transmitter 36 may transmit the log information to the server 16 at any time, may transmit the log information to the server 16 every predetermined period of time, or may transmit the log information to the server 16 when the application program ends the operation thereof.

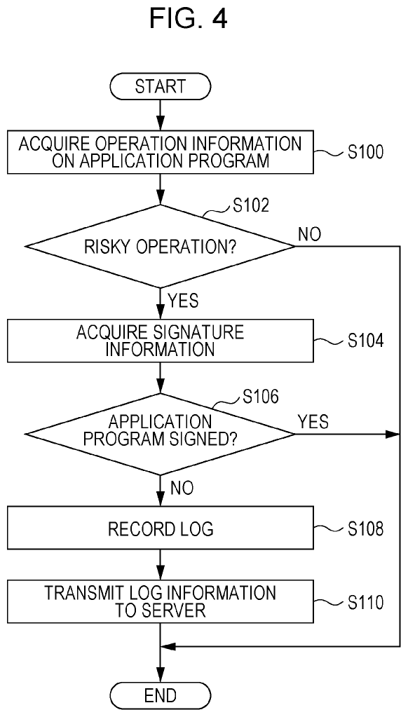

Referring to FIG. 4, the process performed by the image forming apparatus 14 of the first exemplary embodiment is described. When the application program stored on the ROM 22 or the storage 24 starts operating under the control of the CPU 21 in the image forming apparatus 14, the CPU 21 in the image forming apparatus 14 executes the information processing program, thus performing the information processing process in FIG. 4. The information processing process is iterated until the application program ends the operation thereof.

In step S100, the CPU 21 as the operation determiner 30 acquires operation information indicating the operation of the application program.

In step S102, the CPU 21 as the operation determiner 30 determines in accordance with the operation information acquired in step S100 whether the operation of the application program is a risky operation. If the operation of the application program is determined to be a risky operation, processing proceeds to step S104. If the operation of the application program is determined to be not a risky operation, the process ends.

In step S104, the CPU 21 as the signature determiner 32 acquires the signature information on the active application program.

In step S106, the CPU 21 as the signature determiner 32 verifies the signature information acquired in step S104 to determine whether the active application program is signed or not. If the active application program is signed, the process ends. On the other hand, if the active application program is not signed, processing proceeds to step S108.

In step S108, the CPU 21 as the signature determiner 32 stores the log information on the active application program on the log recorder 34.

In step S110, the CPU 21 as the transmitter 36 transmits the log information from the log recorder 34 to the server 16.

In response to the reception of the log information, the server 16 analyzes the log information. If any fault is detected in the log information, the server 16 notifies the administrator of the image forming apparatus 14 of the fault.

The image forming apparatus of the first exemplary embodiment acquires the signature information that indicates whether the application program installed on the image forming apparatus is signed or not. If the signature information indicates that the application program is not signed, the image forming apparatus transmits, to the server, the log information indicating the operation log of the application program. Depending on the reliability of the application program, the image forming apparatus may determine whether to transmit the log information on the application program to the external apparatus. If the application program has performed a risky operation, the log information is transmitted to the server. In comparison with the case where all the log information on the application programs not signed is transmitted to the external apparatus, the log information on an application program having a lower reliability may be transmitted to the external apparatus while an amount of the log information to be transmitted to the external apparatus is reduced. Since the log information is acquired by the server, an attack against the image forming apparatus 14 may be quickly detected.

### Second Exemplary Embodiment

Second exemplary embodiment is described below. An image forming apparatus 14 of the second exemplary embodiment is different from the image forming apparatus 14 of the first exemplary embodiment in that if the application program has performed a risky operation when a user operates the image forming apparatus 14 with the application program signed, the image forming apparatus 14 transmits the log information to the server 16.

If the user himself or herself operates a signed application program, there may be a case in which the application program causes harm to the image forming apparatus 14. If the user operates the image forming apparatus 14 even with the application program signed, the image forming apparatus 14 of the second exemplary embodiment transmits the log information to the server 16.

Specifically, in response to the user entering operation information to the image forming apparatus 14, the operation determiner 30 of the second exemplary embodiment determines whether the application program has performed a risky operation. For example, in response to the operation information entered by the user, the operation determiner 30 determines whether the application program has accessed predetermined data.

The user may enter the operation information to the image forming apparatus 14 via a touch-panel user interface displayed on the display 26 in the image forming apparatus 14 or via a terminal (not illustrated) communicably connected to the communication IF 27.

If the operation determiner 30 determines that the application program has performed a risky operation in response to the operation information entered to the image forming apparatus 14 by the user, the signature determiner 32 stores the log information on the application program on the log recorder 34. The transmitter 36 transmits the log information from the log recorder 34 to the server 16.

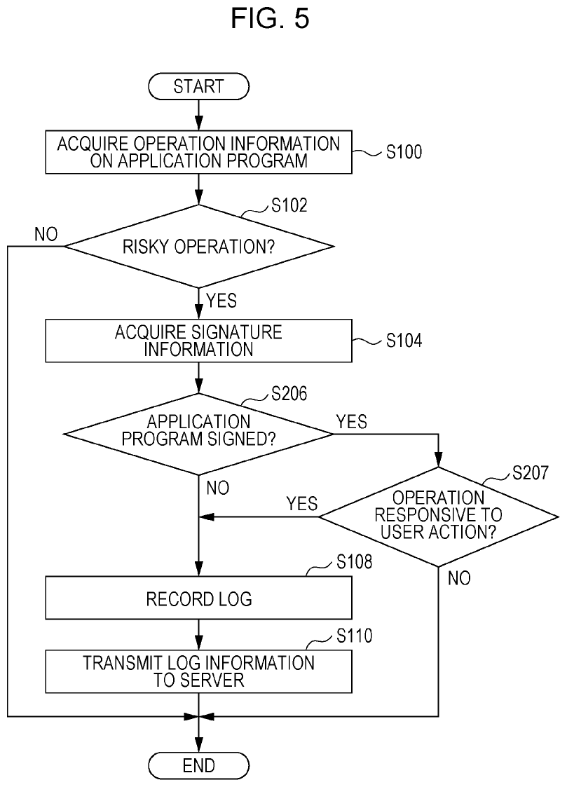

Referring to FIG. 5, the process performed by the image forming apparatus 14 of the second exemplary embodiment is described below. When the application program stored on the ROM 22 or the storage 24 starts operating under the control of the CPU 21 in the image forming apparatus 14, the CPU 21 in the image forming apparatus 14 executes the information processing program, thus performing the information processing process in FIG. 5. The information processing process in FIG. 5 is iterated until the operation of the application program is complete.

Operations in steps S100 through S104 are performed in the same way as in the first exemplary embodiment.

In step S206, the CPU 21 as the signature determiner 32 verifies the signature information acquired in step S104 to determine whether the active application program is signed. If the active application program is signed, processing proceeds to step S207. On the other hand, if the active application program is not signed, processing proceeds to step S108.

In step S207, the CPU 21 as the signature determiner 32 determines whether the application program has performed a risky operation in response to the operation information input to the image forming apparatus 14 by the user. If the application program has performed the risky operation in response to the user operation, processing proceeds to step S108. If the risky operation is not responsive to the user operation, the process ends.

Operations in steps S108 through S110 are performed in the same way as in the first exemplary embodiment.

If the signature information indicates that the application program is signed and the application program has performed a risky operation in response to the operation information input to the image forming apparatus 14 by the user, the image forming apparatus 14 of the second exemplary embodiment transmits the log information to the server. In comparison with the case where all the log information on the active image forming apparatus is transmitted to the server, the log information on an application program more likely to be attributable to the user operation may be transmitted to the server while an amount of the log information to be transmitted to the server is reduced.

### Third Exemplary Embodiment

Third exemplary embodiment is described below. The third exemplary embodiment is different from the first and second exemplary embodiments in that an image forming apparatus 14 of the third exemplary embodiment transmits the log information to the server 16 if the application program is signed but is not a pre-installed application program.

Some of the signed application programs may not pre-installed on the image forming apparatus 14. An later-added-type application program, not pre-installed on the image forming apparatus 14 at shipment, may be less reliable than the pre-installed program.

If the signature information on the active application program indicates that the application program is signed and if the active application program is not a pre-installed program, the image forming apparatus 14 of the third exemplary embodiment stores the log information on the log recorder 34.

Specifically, the signature determiner 32 of the third exemplary embodiment determines whether the application program is a pre-installed program. If the application program is not a pre-installed program with the signature information indicating that the application program is signed, the signature determiner 32 stores the log information on the log recorder 34. The transmitter 36 transmits the log information to the server 16.

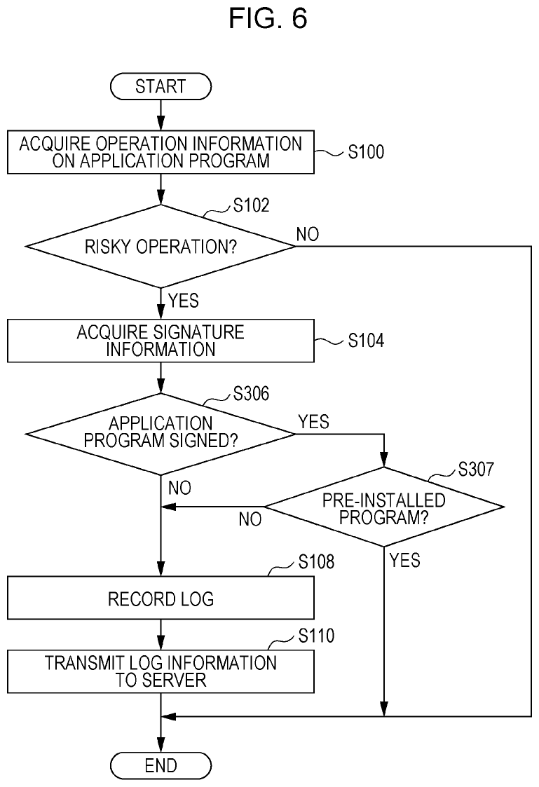

The process performed by the image forming apparatus 14 of the third exemplary embodiment is described below with reference to FIG. 6. When the application program stored on the ROM 22 or the storage 24 starts operating under the control of the CPU 21 in the image forming apparatus 14, the CPU 21 in the image forming apparatus 14 executes the information processing program, thus performing an information processing process in FIG. 6. The information processing process in FIG. 6 is iterated until the operation of the application program is complete.

Operations in steps S100 through S104 are performed in the same way as in the first and second exemplary embodiments.

In step S306, the CPU 21 as the signature determiner 32 verifies the signature information acquired in step S104 to determine whether the active application program is signed. If the active application program is signed, processing proceeds to step S307. On the other hand, if the active application program is not signed, processing proceeds to step S108.

In step S307, the CPU 21 as the signature determiner 32 determines whether the active application program is a pre-installed program. If the active application program is a pre-installed program, the process ends. On the other hand, the active application program is not a pre-installed program, processing proceeds to step S108.

Operations in steps S108 through S110 are performed in the same way as in the first and second exemplary embodiments.

If the application program is not a pre-installed program with the signature information indicating that the application program is signed, the image forming apparatus of the third exemplary embodiment transmits the log information to the server. In this way, if an application program is signed and has a reliability lower than a pre-installed program that is pre-installed at the shipment of the image forming apparatus, the log information on the application program may be transmitted to the server.

The exemplary embodiments have been described. The technical range of the disclosure is not limited to the range of the exemplary embodiments described above. A variety of changes or modifications may be implemented without departing the range of the disclosure. If a change or modification is applied to the embodiments, the resulting embodiments may still fall within the range of the disclosure.

The exemplary embodiments are not intended to limit the disclosure and a combination of all features described in the discussion of the exemplary embodiments may not necessarily be required of the disclosure. The exemplary embodiments includes a variety of stages of the disclosure and a variety of disclosures may be extracted from multiple elements discloses herein. Even if part of the elements disclosed in connection with the exemplary embodiments are removed, a configuration of the remaining elements without the part of the elements may be considered a disclosure.

In the discussion of the exemplary embodiments, the information processing apparatus of the disclosure is the image forming apparatus 14. The information processing apparatus may be a personal computer, a smart phone, or a tablet.

If the application program is signed and performs a risky operation while the user remains logged in on the image forming apparatus 14, the log information may be stored on the log recorder 34 while also being transmitted to the server 16. In such a case, the operation determiner 30 determines whether the image forming apparatus 14 is logged in on by the user. If the image forming apparatus 14 is logged in on by the user and has performed a risky operation, the operation determiner 30 stores the log information on the log recorder 34. For example, if the application program has accessed predetermined data as the risky operation, the operation determiner 30 stores the log information on the log recorder 34. The transmitter 36 transmits the log information from the log recorder 34 to the server 16. In comparison with the case where all the log information with the image forming apparatus 14 in operation is transmitted to the external apparatus, the user may transmit to the external apparatus the log information on the application program more likely to cause the risky operation while the amount of the operation information to be transmitted to the external apparatus is reduced. While the user remains logged in on the image forming apparatus 14, the log information on a risky operation of the application program responsive to a user operation may be transmitted to the server 16.

The image forming apparatus 14 of each of the exemplary embodiments operates in a power saving mode or a normal operation mode. If a signed application program has performed a risky operation in the normal operation mode, the log information is stored on the log recorder 34 while being transmitted to the server 16. In this case, the operation determiner 30 determines whether the image forming apparatus 14 is operating in the normal operation mode. If the image forming apparatus 14 is operating in the normal-operation mode and the signed application program has performed a risky operation, the signature determiner 32 stores the log information on the log recorder 34. For example, if the application program has accessed the predetermined data as the risky operation, the operation determiner 30 stores the log information on the log recorder 34. The transmitter 36 transmits the log information from the log recorder 34 to the server 16. In comparison with the case where the log information on the application program with the image forming apparatus 14 in the power saving mode also being transmitted to the external apparatus, the log information on an application program having a lower reliability may be transmitted to the external apparatus while the amount of the log information to be transmitted to the external apparatus is reduced. Specifically, when the image forming apparatus 14 operates in the normal operation mode, the log information on the risky operation performed by the application program in response to the user operation may be transmitted to the server 16.

If the application program has performed a risky operation while the image forming apparatus 14 of each of the exemplary embodiments is performing a predetermined operation, such as printing, the image forming apparatus 14 may store the log information on the log recorder 34 while also transmitting the log information to the server 16. In such a case, the operation determiner 30 determines whether the image forming apparatus 14 is performing the predetermine operation, such as printing. If the image forming apparatus 14 is performing the predetermined operation and the signed application program has performed the risky operation, the signature determiner 32 stores the log information on the log recorder 34. For example, the application program has accessed the predetermined data as the risky operation, the operation determiner 30 stores the log information on the log recorder 34. The transmitter 36 transmits the log information from the log recorder 34 to the server 16. In comparison with the case where all the log information on the active image forming apparatus 14 is transmitted to the server 16, the log information on an application program having a lower reliability may be transmitted to the server 16 while the amount of the log information to be transmitted to the server 16 is reduced. When the image forming apparatus 14 is performing a job, such as printing, the log information on the risky operation of the application program in response to the user operation may be transmitted to the server 16.

If the image forming apparatus 14 of each of the exemplary embodiments is operated by the user and the signed application program has performed a risky operation, the image forming apparatus 14 may include in the log information a user identification (ID) as identification information on the user. The user who has caused the application program to perform the risky operation may thus be identified.

If the signed application program is not a pre-installed program, the image forming apparatus 14 of each of the exemplary embodiments may include in the log information the user ID as the identification information on the user who has installed the application program. In this way, the user who has installed the application program that has performed the risky operation may be identified.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the embodiments above, and may be changed.

According to the exemplary embodiments, the information processing process is implemented by using a software configuration on a computer, namely, by executing programs on the computer. The disclosure is not limited to this method. The information processing process may be implemented by using a hardware configuration or a combination of hardware and software configurations.

The configuration of the image forming apparatus 14 described with reference to each of the exemplary embodiments has been described for exemplary purposes only. An abundant element may be deleted from or a new element may be added to the exemplary embodiments as long as such does not depart from the scope of the disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
acquire signature information indicating whether an application program installed on the information processing apparatus is signed or not; and
with the signature information indicating that the application program is not signed, transmit log information indicating an operation log of the application program to an external apparatus.

2. The information processing apparatus according to claim 1, wherein the processor is configured to acquire the signature information if the application program has accessed predetermined data.

3. The information processing apparatus according to claim 1, wherein the processor is configured to transmit the log information to the external apparatus if the application program is not a pre-installed program with the signature information indicating that the application program is signed.

4. The information processing apparatus according to claim 2, wherein the processor is configured to transmit the log information to the external apparatus if the application program is not a pre-installed program with the signature information indicating that the application program is signed.

5. The information processing apparatus according to claim 3, wherein the processor is configured to transmit the log information to the external apparatus if the application program has accessed the predetermined data while the information processing apparatus is performing a predetermined operation.

6. The information processing apparatus according to claim 4, wherein the processor is configured to transmit the log information to the external apparatus if the application program has accessed the predetermined data while the information processing apparatus is performing a predetermined operation.

7. The information processing apparatus according to claim 2, wherein the processor is configured to transmit the log information to the external apparatus if a user has logged in on the information processing apparatus with the application program having accessed the predetermined data and with the signature information indicating that the application program is signed.

8. The information processing apparatus according to claim 7, wherein the processor is configured to transmit the log information to the external apparatus if the signature information indicates that the application program is signed with the application program having accessed the predetermined data in response to when the user having logged in on the information processing apparatus enters operation information on the information processing apparatus.

9. The information processing apparatus according to claim 2, wherein the information processing apparatus operates in a power saving mode or a normal operation mode, and
wherein the processor is configured to transmit the log information to the external apparatus if the application program has accessed the predetermined data with the information processing apparatus operating in the normal operation mode.

10. The information processing apparatus according to claim 2, wherein the log information comprises identification information on a user who operates the information processing apparatus or identification information on a user who has installed the application program onto the information processing apparatus.

11. The information processing apparatus according to claim 3, wherein the log information comprises identification information on a user who operates the information processing apparatus or identification information on a user who has installed the application program onto the information processing apparatus.

12. The information processing apparatus according to claim 4, wherein the log information comprises identification information on a user who operates the information processing apparatus or identification information on a user who has installed the application program onto the information processing apparatus.

13. The information processing apparatus according to claim 5, wherein the log information comprises identification information on a user who operates the information processing apparatus or identification information on a user who has installed the application program onto the information processing apparatus.

14. The information processing apparatus according to claim 6, wherein the log information comprises identification information on a user who operates the information processing apparatus or identification information on a user who has installed the application program onto the information processing apparatus.

15. The information processing apparatus according to claim 7, wherein the log information comprises identification information on a user who operates the information processing apparatus or identification information on a user who has installed the application program onto the information processing apparatus.

16. The information processing apparatus according to claim 8, wherein the log information comprises identification information on a user who operates the information processing apparatus or identification information on a user who has installed the application program onto the information processing apparatus.

17. The information processing apparatus according to claim 9, wherein the log information comprises identification information on a user who operates the information processing apparatus or identification information on a user who has installed the application program onto the information processing apparatus.

18. The information processing apparatus according to claim 1, wherein the processor is configured to not transmit the log information to the external apparatus if the signature information indicates that the application program is signed.

19. A non-transitory computer readable medium storing a program causing a computer to execute a process, the process comprising:
acquiring signature information indicating whether an application program installed on an apparatus is signed or not; and
with the signature information indicating that the application program is not signed, transmitting log information indicating an operation log of the application program to an external apparatus.

20. An information processing method comprising:
acquiring signature information indicating whether an application program installed on an apparatus is signed or not; and
with the signature information indicating that the application program is not signed, transmitting log information indicating an operation log of the application program to an external apparatus.
